(19) United States
(12) Patent Application Publication
(10) Pub. No.: US 2020/0272748 A1
(43) Pub. Date: Aug. 27, 2020

(54) METHODS AND APPARATUS FOR VALIDATING MEDIA CONTENT

(71) Applicant: GoPro, Inc., San Mateo, CA (US)

(72) Inventors: Craig Davidson, Cardiff, CA (US); David Newman, San Diego, CA (US)

(21) Appl. No.: 16/802,367

(22) Filed: Feb. 26, 2020

Related U.S. Application Data
(60) Provisional application No. 62/810,775, filed on Feb. 26, 2019.

(51) Int. Cl. G06F 21/62; G06F 21/78; G06F 21/60

(52) U.S. Cl. CPC G06F 21/6209; G06F 21/602; G06F 21/78

(57) ABSTRACT

Apparatus and methods for validating media content. In one aspect, a method for validating captured media data is disclosed. In one embodiment, the method includes receiving the captured media data, the captured media data including encrypted fingerprint data; decrypting the encrypted fingerprint data; comparing the decrypted fingerprint data against other portions of the captured media data; and transmitting results of the comparing. In another aspect, apparatus for validating the captured media is disclosed. This apparatus may include a validation server in some implementations. Methods and apparatus for encrypting fingerprint data associated with captured media content are also disclosed.

### PRIORITY

This application claims the benefit of priority to U.S. Provisional Patent Application Ser. No. 62/810,775 filed Feb. 26, 2019 and entitled “METHODS AND APPARATUS FOR VALIDATING UN-DOCTORED MEDIA CONTENT”, which is incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the disclosure

The present disclosure relates generally to verifying media content and in one exemplary aspect, to methods and apparatus for encrypting characteristics of an original work of authorship prior to its storage in memory as well as methods and apparatus for validating the same.

### Description of Related Art

Digital image capture devices may capture video, audio, and/or still images (collectively referred to as “camera media”) and store this captured camera media in, for example, memory located on the image capture device itself. For example, many digital image capture devices store captured camera media in flash memory cards or other types of fixed or removable memory. This captured camera media may be stored in a variety of imaging file formats including, for example, a Joint Photography Experts Group (JPEG) file format, a Tagged Image File Format (TIFF), as well as various types of Raw imaging formats. Metadata such as, for example, aperture settings, exposure time, focal length, date and time taken, and location information, provide additional information with regards to this captured camera media. Typically, this captured camera media will be shared with third party content distributors (e.g., YouTube® or Instagram®) where it may be consumed by viewers of this captured camera media.

Content authors, as well as content producers and publishers, desire improved methods and apparatus for seeking reliable ways to control access to their media content. Additionally, there are increasing concerns over so-called “deep fakes” or otherwise doctored media content in which experts have had increasing difficulty in determining the authenticity (or originality) of the camera media. Moreover, there currently are no methods for certifying that camera media was originally from a given camera (or image capture device).

While techniques exist that enable one to determine the source of the camera media (e.g., by looking at camera metadata), these techniques can be easily faked or spoofed, or simply copied from valid content using off the shelf tools such as FFmpeg. Accordingly, improved methods and apparatus for validating camera or other device media are needed in order to address the foregoing deficiencies of the prior art. Additionally, such improved methods and apparatus will ideally minimize processing resources while providing the desired level of ability to validate this camera media.

### SUMMARY

The present disclosure addresses the foregoing needs by disclosing, inter alia, apparatus and methods for validating digital media.

In a first aspect of the disclosure, a method for validating captured media data is disclosed. In one embodiment, the method includes: receiving the captured media data, the captured media data comprising encrypted fingerprint data; decrypting the encrypted fingerprint data; comparing the decrypted fingerprint data against other portions of the captured media data. In one variant, the method further includes transmitting results of the comparing.

In another variant, the receiving of the captured media data comprises receiving image or video data, and/or audio data.

In a further variant, the method further includes validating the decrypted fingerprint data against validation information stored on a remote storage apparatus; the decrypting of the encrypted fingerprint data is performed by e.g., the remote storage apparatus.

In another variant, the method further includes extracting the encrypted fingerprint data from at least one of (i) a telemetry data containing track, or (ii) a file recovery data track.

In yet another variant, the transmitting of the results comprises transmitting data associated with an indication of one or more of (i) whether an entirety of the media data is original, (ii) whether a portion of the media data is original, (iii) whether none of the media data is original, or (iv) whether a portion of the media data has been removed.

In a further variant, the method further includes marking the media data as authentic based at least on the results indicating successful validation.

In another embodiment of the method of validating, the method includes: obtaining the media data via one or more camera devices; encrypting metadata associated with the obtained media data; inserting the encrypted metadata into a designated portion of the obtained media data to produce modified media data having the encrypted metadata; and enabling validation of the modified media data by a computerized apparatus, the computerized apparatus being configured to compare the encrypted metadata of the modified media data against metadata stored on the computerized apparatus.

In one variant, the media data comprises image data and audio data both captured by at least one of the one or more camera devices. In one implementation thereof, the metadata associated with the obtained media data comprises one or more of (i) fingerprint data associated with one or more of the image data or the audio data, or (ii) a time sequence associated with a plurality of frames of the obtained media data.

The inserting of the encrypted metadata into the designated portion of the obtained media may include e.g., inserting the encrypted metadata into (i) a metadata track associated with a frame of the plurality of frames of the obtained media data, or (ii) a portion of the obtained media data that does not contain video or audio data.

In another implementation, the method further includes generating the fingerprint data based at least on identifying one or more unique characteristics associated with at least a sampled portion of the obtained media data.

The generating of the fingerprint data may also include generating one or more of an image fingerprint or an audio fingerprint.

In a further variant, the method further includes obtaining the sampled portion by obtaining one or more portions of the obtained media data for every given time interval.

In another aspect of the disclosure, computerized apparatus is disclosed. In one embodiment, the apparatus is configured to validate obtained media data, and includes: one or more content capturing devices; processor apparatus configured to perform data communication with the one or more content capturing devices; and non-transitory computer-readable apparatus in data communication with the processor apparatus.

In one variant, the non-transitory computer-readable apparatus includes a storage medium comprising at least one computer program, the at least one computer program including a plurality of instructions configured to, when executed by the processor apparatus, cause the computerized apparatus to: capture content via the one or more content capturing devices, the captured content comprising image data and audio data; encrypt unique data associated with the captured content; and insert the encrypted unique data into a portion of the captured content, thereby generating content with encrypted unique data.

In one implementation, the generated content with encrypted unique data is configured to allow a computerized device obtaining the generated content with encrypted unique data to: decrypt the encrypted unique data validate the decrypted unique data; and transmit results of the validation to the computerized apparatus.

In another variant, the unique data comprises one or more of a fingerprint of the captured content, or a time sequence of a sequence of frames associated with the captured content, the fingerprint comprising an image fingerprint and an audio fingerprint.

In a further variant, the one or more content capturing devices comprise an image sensor and a microphone; the image sensor is configured to generate the image fingerprint; and the microphone is configured to generate the audio fingerprint. The encryption of the unique data comprises an encryption of the image fingerprint and an encryption of the audio fingerprint, the encryptions of the image fingerprint and the audio fingerprint being performed separately from each other.

In another variant, the plurality of instructions are further configured to, when executed by the processor apparatus, cause the computerized apparatus to transmit the generated content with encrypted unique data to the computerized device, the computerized device comprising a validation server entity.

In yet another variant, the validation includes one or more of (i) a comparison against a version of the unique data stored on the computerized device, or (ii) a comparison against another portion of the generated content with encrypted unique data.

In a further aspect, an integrated circuit (IC) device configured to perform media data fingerprinting is disclosed. In one embodiment, the integrated circuit is embodied as a SoC (system on Chip) device. In another embodiment, an ASIC (application specific IC) is used as the basis of the device. In yet another embodiment, a chip set (i.e., multiple ICs used in coordinated fashion) is disclosed. In yet another embodiment, the device comprises a multi-logic block FPGA device. In one embodiment, the integrated circuit is configured to execute a plurality of functions. In one variant, at least some of the functions are performed via hardware. In one variant, at least some of the functions are received in software.

In another aspect, a computer readable storage apparatus implementing one or more of the foregoing aspects is disclosed and described. In one embodiment, the computer readable apparatus comprises a program memory, or an EEPROM.

In another aspect, a network process and architecture configured to interface with a computerized device (e.g., action camera, smartphone, tablet or PC) is disclosed. In one embodiment, the process is a network server process (e.g., cloud-based) and employs an architecture to establish communication between the computerized device at a premises or in mobile use and the network server process. The network process is in one implementation a computerized process configured to enable validation of media data based on submission of encrypted fingerprint data by the computerized device via a network interface such as a 3GPP 5G NR wireless link.

In another aspect, methods and apparatus for repurposing extant tracks or portions of a media container or file are disclosed. In one embodiment, an extant telemetry or file recovery track (or both) are utilized to retain encrypted fingerprint data.

In another aspect, methods and apparatus for utilizing fingerprint or similar media validation data while maintaining backward compatibility with prior formats is disclosed. In one embodiment, the fingerprint data (which may or may not be encrypted) is disposed within an mp4 or mov container structure without indexing (i.e., is in effect hidden) such that it requires no indexing or accounting within the container structure. The data is extractable by a validating process (e.g., another mobile device, PC, or network server), yet appears completely transparent to extant processing entities.

In another aspect of the disclosure, a system is disclosed. In one embodiment, the system includes a media data generating process, and a media data validating process. In one variant, the generating process is a mobile device which generates and includes encrypted fingerprint data within a metadata or other ancillary track of the media data, and the validating process extracts the fingerprint data to validate the media data before e.g., rendering or subsequent processing (including post-processing such as filtering, feathering, stitching, etc.).

In a further aspect of the disclosure, a media data structure format is disclosed. In one embodiment, the data structure includes a plurality of compressed media data (e.g., video and audio), as well as one or more ancillary portions (e.g., tracks) containing fingerprinting data. In one implementation, the fingerprinting data is disposed on the ancillary portions without indexing or accounting for file size or other parameters, thereby maintaining backwards compatibility. In one configuration, the data structures comprise mov or mp4 container formats with GPMF or SOS tracks as the ancillary portions, the tracks which contain telemetry and file recovery data as well as encrypted fingerprint data.

### BRIEF DESCRIPTION OF THE DRAWINGS

FIG. 1 is a block diagram of an exemplary capture device that encrypts a camera media fingerprint, in accordance with the principles of the present disclosure.

FIG. 2 is a graphical illustration of an exemplary frame of imaging content with an encrypted camera media fingerprint, useful in describing the principles of the present disclosure.

FIG. 3 is a logical flow diagram illustrating an exemplary methodology for the storing of captured camera media, useful in describing the principles of the present disclosure.

FIG. 4 is a logical flow diagram illustrating an exemplary methodology for the validation of captured camera media, useful in describing the principles of the present disclosure.

FIG. 5 is a block diagram of an exemplary implementation of a computing device, useful in encrypting and/or decrypting fingerprint data, useful in describing the principles of the present disclosure.

All Figures disclosed herein are © Copyright 2020 GoPro, Inc. All rights reserved.

### DETAILED DESCRIPTION

Implementations of the present technology will now be described in detail with reference to the drawings, which are provided as illustrative examples and species of broader genus' so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Moreover, while primarily discussed in the context of encrypting/validating camera media within the context of a standalone camera (e.g., a GoPro Fusion® camera manufactured by the Assignee hereof, a GoPro Hero® camera, etc.), the present disclosure is not so limited. In fact, the methodologies and apparatus described herein may be readily applied to other types of image capture devices or non-image capture devices. For example, the principles of the present disclosure may be readily applied to other types of computing devices such as, for example, a desktop computer, a laptop computer, a tablet computer, etc., whether they are capable of image capture or otherwise.

These and other variations would be readily apparent to one of ordinary skill given the contents of the present disclosure.

### Exemplary Capture Apparatus

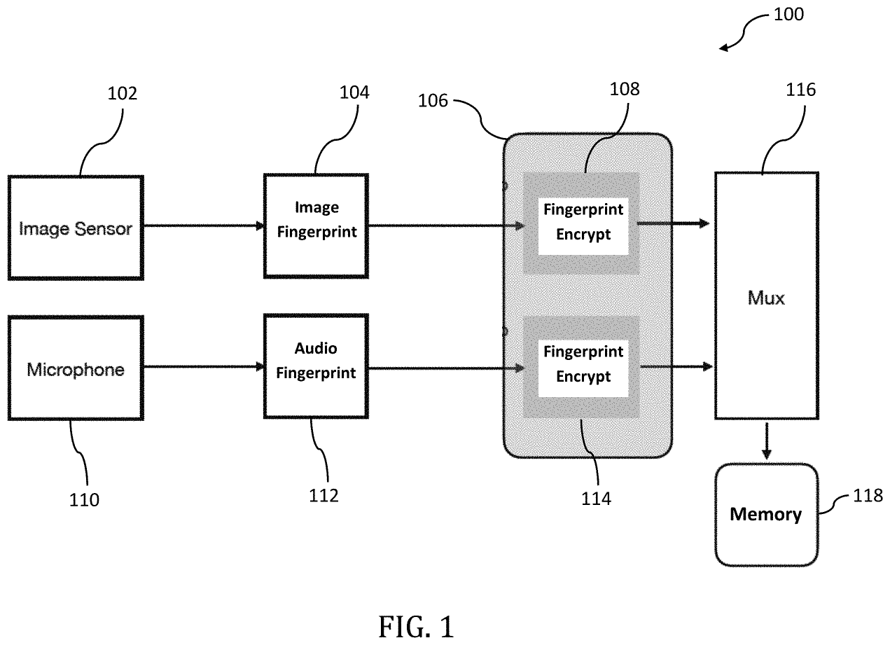

Referring now to FIG. 1, an exemplary capture device 100 that encrypts a fingerprint of captured content is shown and described in detail. The capture device 100 may include one or more image sensors 102. The one or more image sensors 102 may capture digital images (e.g., still photos) or video. In the context of captured video, the images captured can be thought of as a sequence of images (or a sequence of “frames”). Each captured image may include a two-dimensional array of pixels. The captured images or frames depict a “scene,” which may include, for example, landscape, people, objects, that are each represented by captured pixels. Each pixel represents a depicted point in a scene captured in, for example, the digital video. Furthermore, each pixel is located at a pixel location, referring to, for example, (x,y) coordinates of the pixel within the image or frame. For example, a pixel may comprise {Red, Green, Blue} (RGB) values describing the relative intensities of the colors sensed by the one or more image sensors 102 at a particular set of (x,y) coordinates in the frame. In some implementations, the one or more image sensors 102 may capture video suitable for providing output videos having high definition resolutions (for example, 4K resolution, 2K resolution, 1080 p, 1080 i, 960 p, 720 p and the like), standard definition resolutions, or other types of resolutions. The one or more image sensors 102 may capture video at one or more frame rates such as, for example, 120 frames per seconds (FPS), 60 FPS, 48 FPS, 30 FPS and any other suitable frame rate. Additionally, the one or more image sensors 102 may include a lens that allows for wide-angle or ultra wide-angle video capture having a field of view (FOV) of, for example, 90 degrees, 127 degrees, or 170 degrees, 180+ degrees, although other FOV angles may be used.

For example, in the context of the GoPro Fusion® series of cameras manufactured by the Assignee hereof, the image capture device 100 may include a pair of image sensors (with respective lens') that are arranged in a generally back-to-back orientation with each of the image sensors capturing a hyper-hemispherical FOV. In the context of a traditional GoPro Hero® series of cameras manufactured by the Assignee hereof, a single image sensor 102 may capture a scene. The capture device 100 may further include one or more microphones 110 that capture the sounds associated with, for example, a captured scene. For example, in some implementations, a plurality of microphones 110 are utilized by the capture device 100 in order to provide, inter alia, directionality of sound for objects within the captured scenes. In some implementations, a single microphone 110 may be present on the capture device 100. These and other variations would be readily apparent to one of ordinary skill given the contents of the present disclosure.

The capture device 100 may further include one or more processing module(s) 104, 112 that is capable of extracting a fingerprint from the captured media. For example, a processing module 104 may take imaging data and generate an image fingerprint of that imaging data. Additionally, or alternatively, a processing module 112 may take captured audio data and generate an audio fingerprint of that captured audio data. While illustrated as having distinct processing modules 104, 112 for generating an image fingerprint and an audio fingerprint, respectively, it would be readily apparent to one of ordinary skill given the contents of the present disclosure that such image/audio fingerprint functionality may be generated by a single hardware (and/or software) processing entity.

As a brief aside, the generating of camera media fingerprints is accomplished via the analyzing of the captured camera media in order to determine the unique characteristics of the content. In some implementations, the entire captured camera media is analyzed to determine the image/audio fingerprint; however, such a fingerprint generating module may be computationally intensive and/or may take up a large amount of memory resources. Accordingly, in some implementations, a subset of the captured camera media may be analyzed to determine the image/audio fingerprint. For example, a statistical sampling of the captured media content may be utilized for the generation of a fingerprint (e.g., three samples may be taken every tenth of a second). Such an implementation may take less processing resources and less memory resources as compared with an implementation that takes the entirety of the captured camera media for the generation of image and/or audio fingerprints.

In addition to, or alternatively from, the generation of camera media fingerprints, data indicative of a time sequence may also be encrypted. For example, a frame number associated with a sequence of frames of captured video may also be encrypted. In some implementations, the encrypted data indicative of a time sequence for a sequence of frames may be dependent upon surrounding frame(s). In other words, similar to many extant blockchain algorithms, a given frame may include a unique code (e.g., hash) as well as a unique code (hash) of one or more prior frames within a sequence of frames. Accordingly, detection of altered content may be easily detected. Such an implementation may be useful in determining, for example, whether a captured sequence of frames has been altered (e.g., by trimming out/discarding portions of the captured sequence of frames). In other words, upon decryption of the encrypted data indicative of a time sequence, the alteration of the sequence of frames may be detected. For example, upon decryption, it may be determined that the beginning of the sequence of frames has been altered, and/or that middle portion(s) of the sequence of frames has been altered. Additionally, the last frame of a sequence of frames may include a frame condition that enables determination of that the end of a sequence of frames has been altered. For example, this frame condition may include data that may only be known to the manufacturer of the camera (or image capture device).

Once the fingerprints (e.g., video, audio and/or time sequence) have been generated, these fingerprints are passed along to an encryption engine 106. In some implementations, the encryption engine 106 may be a part of the video encoder and/or the audio encoder of the capture device 100. The encryption engine 106 may be configured to encrypt image fingerprints (e.g., video) and/or audio fingerprints, via an image encrypt module 108 and audio encrypt module 114, respectively. The encrypt modules 108, 114 may include one of a symmetric key/private key encryption mechanism or a public key encryption mechanism. In symmetric key schemes, the encryption keys and decryption keys are the same. In public-key encryption schemes, the encryption key may be published for anyone to use and encrypt data, however, the party that wishes to decrypt the encrypted images or audio must have access to a decryption key that enables data to be decrypted and read. The encrypt modules 108, 114 may utilize a block cipher such as, for example, the Advanced Encryption Standard (AES) 128-bit block cipher.

In some implementations, the encryption engine 106 may utilize a keyed-hash message authentication code (HMAC). An HMAC is a type of message authentication code that involves the use of a cryptographic hash function and a secret cryptographic key. Use of an HMAC may be advantageous as it may be used to simultaneously verify both the data integrity and the authentication of the captured camera media. The use of an HMAC may require two passes of hash computation. For example, a secret key may be first used to derive two keys. These derived keys may include an inner key and an outer key. Next, a second pass produces the final HMAC code derived from the inner hash result and the outer key, which provides the HMAC algorithm with better immunity against, for example, length extension attacks. The encrypted fingerprint may then be inserted into the frame of captured content. For example, the encrypted fingerprint may be stored in a metadata track of the captured content, or may be stored in the white space of the frame of captured content.

Advantageously, the encryption would be highly secure, but as it would be only encrypting the fingerprint, the encryption methodology would be relatively fast (i.e., not computationally expensive) and would otherwise have no impact on compatibility with existing playback and editing tools. In some implementations, a multiplexer (MUX) 116 may be used to insert the encrypted image fingerprint, encrypted audio fingerprint and/or encrypted time sequence fingerprint into the frame, prior to being stored to memory 118.

In another alternative, an existing track (such as e.g., GPMF or SOS tracks). As a brief aside, the GPMF (GoPro Metadata Format or General Purpose Metadata Format) is a structured storage format was originally proposed to store high-frequency periodic sensor data within a video file such as e.g., an MP4. Certain devices such as some action cameras have limited computing resources beyond that needed to store video and audio, so any telemetry storage needed to be lightweight in computation, memory usage and storage bandwidth. The GPMF structure according to the present disclosure may be used stand-alone, or in conjunction with an additional time-indexed track with e.g., an MP4, and with an application marker within JPEG images. GPMF share a Key, Length, Value structure (KLV), similar to QuickTime atoms or Interchange File Format (IFF), but utilize an optimal KLV system that is better for describing sensor data. GPMF is a modified Key, Length, Value solution, with a 32-bit aligned payload, that is both compact, full extensible and somewhat human readable in a hex editor. GPMF allows for dependent creation of new FourCC tags, without requiring central registration to define the contents and whether the data is in a nested structure. GPMF is optimized as a time of capture storage format for the collection of sensor data as it happens.

SOS is another type of track which may be present (typically used for e.g., file recovery) and in the present context, used as a repository for encrypted fingerprint data of the type previously described.

In yet another approach, one or more metadata tracks within or associated with the video data may be utilized for carrying data such as the aforementioned encrypted fingerprint data. In one variant, linking to the GPMF application is utilized.

It will be recognized that in some embodiments, the data being “fingerprinted” is compressed before fingerprinting, such as where video and audio data is compressed into H.264/HEVC and AAC data respectively. The use of compressed data advantageously makes the fingerprinting process faster, and also makes surreptitious attacks on the data much harder to perform.

In one embodiment, the compressed video data and audio data is placed within an mp4, or mov container, as chunks of compressed data. In one variant, video (H264/HEVC) and AAC audio are interleaved, and metadata is added in the form of GPMF (sensor metadata) data and SOS track (file recovery) data. In one such implementation, not all of the data within the mp4 is accounted by some track data (index to a payload and size of the payload), in contrast to prior approaches wherein a complete accounting is utilized. As such, additional space for the fingerprint data referenced previously can be placed before and/or after each payload, and not described in the mp4/mov index. This approach advantageously avoids potential compatibility issues, since the added data is in effect “invisible” and hence any process utilizing the index will see what amounts to an unmodified mp4/mov.

As previously noted, the fingerprint data may also be placed within the SOS track, as the SOS track currently describes each payload to enable file recovery in the event of a capture failure (e.g., battery extraction during capture). In one variant, the nominal or extant SOS track data (for file recovery) is expanded to include encrypted fingerprint data. Similarly, this approach has no impact on the existing ecosystem, since such data is effectively invisible to other algorithms (e.g., the file recovery process or indexes). Advantageously, the existing GPMF track or SOS track can also store encrypted fingerprint data with no impact to playback compatibility.

One exemplary usage scenario for the aforementioned encryption methodology may be for, for example, body camera footage captured by a law enforcement officer. Accordingly, the footage captured by the body camera may be authenticated to ensure that it is a true and accurate representation of the events surrounding the capture. Another exemplary usage scenario for the aforementioned encryption methodology may be for, for example, security camera footage. Accordingly, the security camera footage captured by the security camera may be authenticated to ensure that it is, again, a true and accurate representation of the events surrounding the capture. These and other usage scenarios would be readily apparent to one of ordinary skill given the contents of the present disclosure.

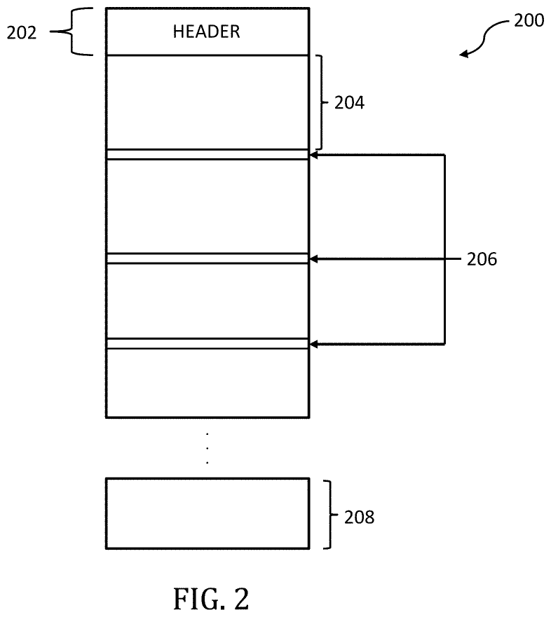

Referring now to FIG. 2, an exemplary media file 200 that includes encrypted fingerprint camera media is shown and described in detail. In some implementations, the media file 200 may take the form of, for example, an MPEG-4 (mp4) file format, a MOV file extension format, and/or any other suitable file format. The file 200 may include a header 202 as well as a frame or group of pictures (GOP) portion 204 within the file. The encrypted fingerprint information 206 (e.g., an HMAC) may be encoded between the frame or GOP portions 204. The media file 200 may further include an index 208 which may be utilized by playback or editing tools so that the encrypted fingerprint information 206 may be ignored. The encrypted fingerprint information 206 may be separately transmitted to a validation server (not shown) so that the camera media may be validated at a later time. For example, the Assignee hereof (GoPro®), or other camera vendor(s), may manage the secret clip validation key and/or may provide a web-portal for clip validation. The validation methodology may report whether the entire camera media file 200 is original, if the original camera media file 200 has been trimmed, whether portions of the camera media file are original, and/or that none of the camera media file 200 is original. Validation may be useful for, for example, third party services (e.g., YouTube® or Instagram®) so that these third party services can request clip validation from the validation server. Upon validation, the camera media file 200 may be marked as authenticated.

Encrypting/Validating Methodologies

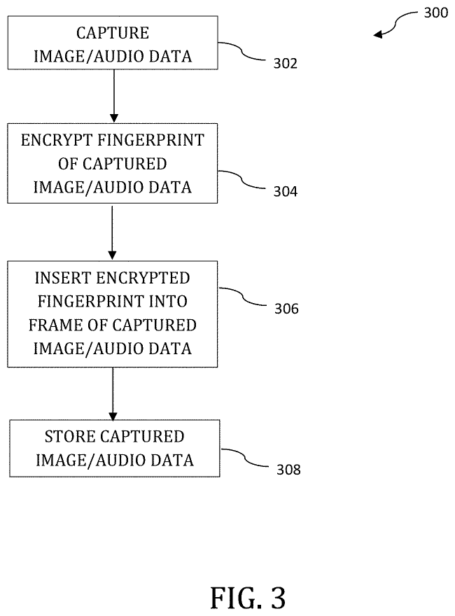

Referring now to FIG. 3, an exemplary logical flow diagram illustrating an exemplary methodology 300 for the storing of captured image/audio data is shown and described in detail. At operation 302, imaging and/or audio data (collectively, “camera media”) is captured. This captured media may be obtained using a variety of types of image capture devices (e.g., cameras). For example, panoramic captured media may be obtained using, for example, the GoPro Fusion® series of cameras manufactured by the Assignee hereof. As but one other non-limiting example, captured media may be obtained using, for example, a GoPro Hero® series of cameras manufactured by the Assignee hereof. These and other variations would be readily apparent to one of ordinary skill given the contents of the present disclosure.

At operation 304, the fingerprint of the captured camera media and/or time sequence of a sequence of frames may be encrypted. For example, the fingerprint may be obtained from the captured imaging content. As but another non-limiting example, the fingerprint may be obtained from the captured audio content. In some implementations, the fingerprint may be obtained from both the captured imaging content as well as the captured audio content. Additionally, or alternatively, the time sequence encryption may be dependent upon, for example, previously encrypted (or hashed) time sequence data.

At operation 306, the encrypted fingerprint may be inserted into a frame of captured camera media. For example, the encrypted fingerprint data may be inserted into a metadata track. In some implementations, the encrypted fingerprint data may be inserted into the white space between encoded video and audio. An index may also be inserted into the media file in some implementations which enables extant playback or editing tools to simply ignore the inserted encrypted fingerprint data.

At operation 308, the captured image/audio data with the encrypted fingerprint data is stored. For example, this captured image/audio data may be stored locally on the image capture device. In some implementations, this captured image/audio device may be stored remote from the image capture device (e.g., on a computerized apparatus).

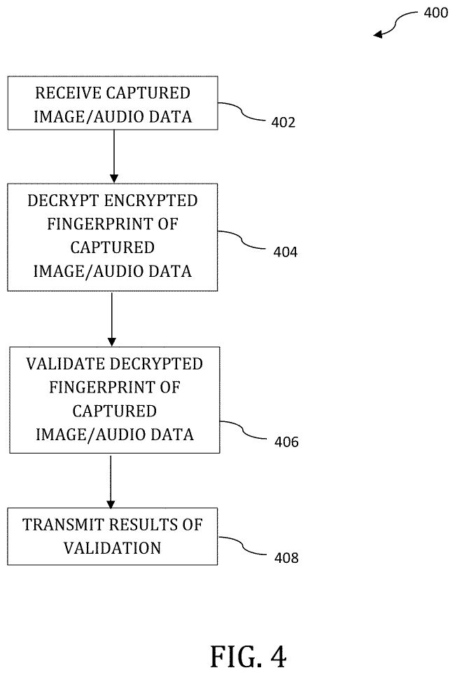

Referring now to FIG. 4, a logical flow diagram illustrating an exemplary methodology 400 for validation of captured image/audio data is shown and described in detail. At operation 402, the captured image/audio data with the encrypted fingerprint data is received. At operation 404, the encrypted fingerprint data is decrypted by, for example, a validation server. At operation 406, the decrypted fingerprint data is validated against fingerprint data that was previously provided to the validation server. In other implementations, the decrypted fingerprint data is compared against the captured image/audio data received at operation 402. At operation 408, the results of the validation are transmitted back towards the original requester of the validation. The validation may indicate whether the entire camera media file is original, may indicate if the original camera media file has been trimmed, whether portions of the camera media file are original, and/or that none of the camera media file is original. Upon validation, the camera media file may be marked as authenticated.

Exemplary Apparatus

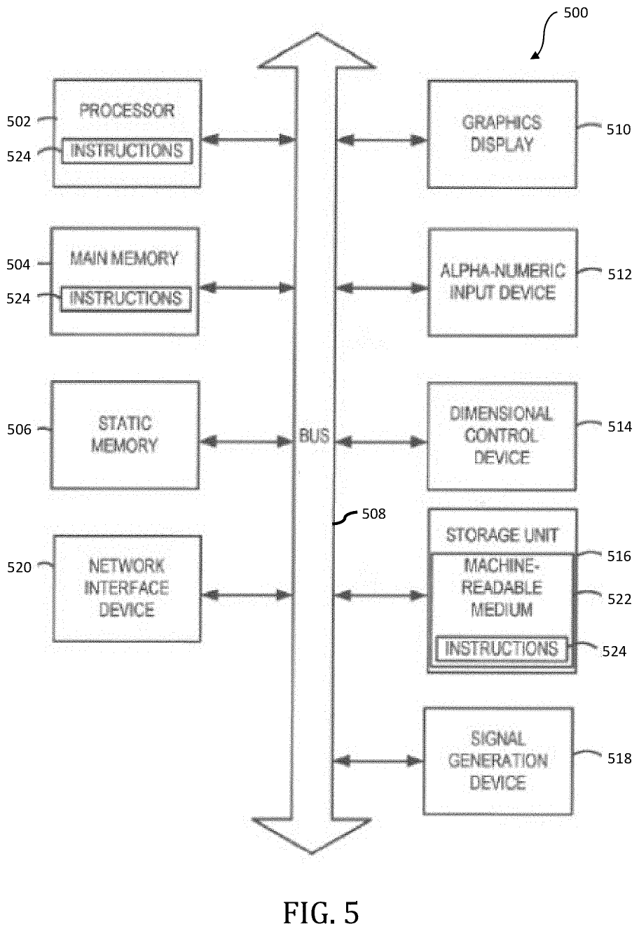

FIG. 5 is a block diagram illustrating components of an example computing system 500 able to read instructions from a computer-readable medium and execute them in one or more processors (or controllers). The computing system 500 in FIG. 5 may represent an implementation of, for example, an image capture device (100, FIG. 1) for encrypting a fingerprint of a captured image. The computing system 500 may include a separate standalone computing device (e.g., a laptop, desktop, server, etc.) in some implementations. For example, the computing system may include a validation server that is used to validate the authenticity of captured content.

The computing system 500 may be used to execute instructions 524 (e.g., program code or software) for causing the computing system 500 to perform any one or more of the methodologies (or processes) described herein. The computing system 500 may include, for example, an action camera (e.g., a camera capable of capturing, for example, a 360° FOV), a personal computer (PC), a tablet PC, a notebook computer, or other device capable of executing instructions 524 (sequential or otherwise) that specify actions to be taken. In another embodiment, the computing system 500 may include a server. In a networked deployment, the computing system 500 may operate in the capacity of a server or client in a server-client network environment, or as a peer device in a peer-to-peer (or distributed) network environment. Further, while only a single computer system 500 is illustrated, a plurality of computing systems 500 may operate to jointly execute instructions 524 to perform any one or more of the methodologies discussed herein.

The example computing system 500 includes one or more processing units (generally processor apparatus 502). The processor apparatus 502 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of the foregoing. The computing system 500 may include a main memory 504. The computing system 500 may include a storage unit 516. The processor 502, memory 504 and the storage unit 516 may communicate via a bus 508. One or more of the storage unit 516, main memory 504, and static memory 506 may be utilized to store, inter alia, media (e.g., image data and/or audio data) that includes the encrypted fingerprint data.

In addition, the computing system 500 may include a display driver 510 (e.g., to drive a plasma display panel (PDP), a liquid crystal display (LCD), a projector, or other types of displays). The computing system 500 may also include input/output devices, e.g., an alphanumeric input device 512 (e.g., touch screen-based keypad or an external input device such as a keyboard), a dimensional (e.g., 2-D or 3-D) control device 514 (e.g., a touch screen or external input device such as a mouse, a trackball, a joystick, a motion sensor, or other pointing instrument), a signal capture/generation device 518 (e.g., a speaker, camera, and/or microphone), and a network interface device 520, which also are configured to communicate via the bus 508.

Embodiments of the computing system 500 corresponding to a client device may include a different configuration than an embodiment of the computing system 500 corresponding to a server. For example, an embodiment corresponding to a server may include a larger storage unit 516, more memory 504, and a faster processor 502 but may lack the display driver 510, input device 512, and dimensional control device 514. An embodiment corresponding to an action camera may include a smaller storage unit 516, less memory 504, and a power efficient (and slower) processor 502 and may include one or more image capture devices 518.

The storage unit 516 includes a computer-readable medium 522 on which is stored instructions 524 (e.g., a computer program or software) embodying any one or more of the methodologies or functions described herein. The instructions 524 may also reside, completely or at least partially, within the main memory 504 or within the processor 502 (e.g., within a processor's cache memory) during execution thereof by the computing system 500, the main memory 504 and the processor 502 also constituting computer-readable media. The instructions 524 may be transmitted or received over a network via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store the instructions 524. The term “computer-readable medium” shall also be taken to include any medium that is capable of storing instructions 524 for execution by the computing system 500 and that cause the computing system 500 to perform, for example, one or more of the methodologies disclosed herein.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “computing device”, includes, but is not limited to, image capture devices (e.g., cameras), personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “camera” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method for validating captured media data, the method comprising:
receiving the captured media data, the captured media data comprising encrypted fingerprint data;
decrypting the encrypted fingerprint data;
comparing the decrypted fingerprint data against other portions of the captured media data; and
transmitting results of the comparing.

2. The method of claim 1, wherein the receiving of the captured media data comprises receiving image or video data.

3. The method of claim 1, wherein the receiving of the captured media data comprises receiving audio data.

4. The method of claim 1, further comprising validating the decrypted fingerprint data against validation information stored on a remote storage apparatus;
wherein the decrypting of the encrypted fingerprint data is performed by the remote storage apparatus.

1. method of claim 1, further comprising extracting the encrypted fingerprint data from at least one of (i) a telemetry data containing track, or (ii) a file recovery data track.

6. The method of claim 1, wherein the transmitting of the results comprises transmitting data associated with an indication of one or more of (i) whether an entirety of the media data is original, (ii) whether a portion of the media data is original, (iii) whether none of the media data is original, or (iv) whether a portion of the media data has been removed.

7. The method of claim 1, further comprising marking the media data as authentic based at least on the results indicating successful validation.

8. A method for enabling validation of captured media data, the method comprising:
obtaining the media data via one or more camera devices;
encrypting metadata associated with the obtained media data;
inserting the encrypted metadata into a designated portion of the obtained media data to produce modified media data having the encrypted metadata; and
enabling validation of the modified media data by a computerized apparatus, the computerized apparatus being configured to compare the encrypted metadata of the modified media data against metadata stored on the computerized apparatus.

9. The method of claim 8, wherein the media data comprises image data and audio data both captured by at least one of the one or more camera devices.

10. The method of claim 9, wherein the metadata associated with the obtained media data comprises one or more of (i) fingerprint data associated with one or more of the image data or the audio data, or (ii) a time sequence associated with a plurality of frames of the obtained media data.

11. The method of claim 10, wherein the inserting of the encrypted metadata into the designated portion of the obtained media comprises inserting the encrypted metadata into (i) a metadata track associated with a frame of the plurality of frames of the obtained media data, or (ii) a portion of the obtained media data that does not contain video or audio data.

12. The method of claim 11, further comprising generating the fingerprint data based at least on identifying one or more unique characteristics associated with at least a sampled portion of the obtained media data.

13. The method of claim 12, wherein the generating of the fingerprint data comprises generating one or more of an image fingerprint or an audio fingerprint.

14. The method of claim 12, further comprising obtaining the sampled portion by obtaining one or more portions of the obtained media data for every given time interval.

15. Computerized apparatus configured to validate obtained media data, the computerized apparatus comprising:
one or more content capturing devices;
processor apparatus configured to perform data communication with the one or more content capturing devices; and
non-transitory computer-readable apparatus in data communication with the processor apparatus, the non-transitory computer-readable apparatus comprising a storage medium comprising at least one computer program, the at least one computer program comprising a plurality of instructions configured to, when executed by the processor apparatus, cause the computerized apparatus to:
capture content via the one or more content capturing devices, the captured content comprising image data and audio data;
encrypt unique data associated with the captured content; and
insert the encrypted unique data into a portion of the captured content, thereby generating content with encrypted unique data.

16. The computerized apparatus of claim 15, wherein the generated content with encrypted unique data is configured to allow a computerized device obtaining the generated content with encrypted unique data to:
decrypt the encrypted unique data;
validate the decrypted unique data; and
transmit results of the validation to the computerized apparatus.

17. The computerized apparatus of claim 15, wherein the unique data comprises one or more of a fingerprint of the captured content, or a time sequence of a sequence of frames associated with the captured content, the fingerprint comprising an image fingerprint and an audio fingerprint.

18. The computerized apparatus of claim 17, wherein:
the one or more content capturing devices comprise an image sensor and a microphone;
the image sensor is configured to generate the image fingerprint;
the microphone is configured to generate the audio fingerprint; and
the encryption of the unique data comprises an encryption of the image fingerprint and an encryption of the audio fingerprint, the encryptions of the image fingerprint and the audio fingerprint being performed separately from each other.

19. The computerized apparatus of claim 15, wherein the plurality of instructions are further configured to, when executed by the processor apparatus, cause the computerized apparatus to transmit the generated content with encrypted unique data to the computerized device, the computerized device comprising a validation server entity.

20. The apparatus of claim 15, wherein the validation comprises one or more of (i) a comparison against a version of the unique data stored on the computerized device, or (ii) a comparison against another portion of the generated content with encrypted unique data.
